(19) United States
(12) Patent Application Publication
(10) Pub. No.: US 2007/0248339 A1
(43) Pub. Date: Oct. 25, 2007

(54) Water gravity electric generator

(76) Inventor: Takeshi Akiyama, San Diego, CA (US)

Correspondence Address: LEWIS, BRISBOIS, BISGAARD & SMITH LLP, 221 NORTH FIGUEROA STREET, SUITE 1200, LOS ANGELES, CA, 90012, US

(21) Appl. No.: 11/408,191

(22) Filed: Apr. 20, 2006

(51) Int. Cl. F24H 1/18

(52) U.S. Cl. 392/441

(57) ABSTRACT

A system for generating electricity for a structure, such as a home or building, receiving a water supply under pressure, comprising a plurality of oscillating tanks adapted to move from an upper position to a lower position by gravity, means to fill a tank with water from the water supply when the tank reaches its upper position, means to empty the water in the tank when the tank reaches its lower position by gravity, said water being passed back into the structure water supply, a generator having a shaft, means to turn the shaft by the oscillating movement of the tanks.

### FIELD OF THE INVENTION

The present invention relates to a system for producing electricity by the use of gravity.

### BACKGROUND OF THE INVENTION

Systems have been described for the generation of electricity using water tanks that are filled with water and move by gravity to turn a generator to produce electricity. A typical system is described in U.S. patent application Ser. No. 5,905,312, issued to Liou on May 18, 1999. The problem with the Liou system, and others which are similar, is that the water that is emptied from the tanks must be pumped back up to an upper water supply tank to be used again. So much power is expended to pump the water back up to the upper tank, that much of the power generated by the system is utilized, greatly reducing the net power generated.

### SUMMARY OF THE INVENTION

It is an object of the present invention to generate electricity by gravity without expending power to pump water back to an upper tank.

This invention utilizes the standard water flow present in structures, such as homes and businesses, to alternately fill and empty an oscillating set of water tanks, which move by gravity to turn a generator shaft and generate electricity. The water emptied from the oscillating tanks is not pumped back to an upper tank but is simply passed back into the water system in the house or building, to be used in the same manner as if the electricity generating system were not present.

The water pressure normally present in any structure, household or business, from the water company that provides water to the municipality in which the home or business is located, is utilized to fill the water tanks of this invention. No additional power is required, as the water pressure is easily sufficient to fill the tanks. The water, when emptied from the water tank at the lower end of the cycle, is put back into the water system of the house or business and utilized for cooking, bathing, etc. as if the electricity generating system were not present.

### BRIEF DESCRIPTION OF THE DRAWINGS

FIG. 1 is an elevational side view of the system of this invention;

FIG. 2 is a front view of the system.

### DETAILED DESCRIPTION OF THE INVENTION

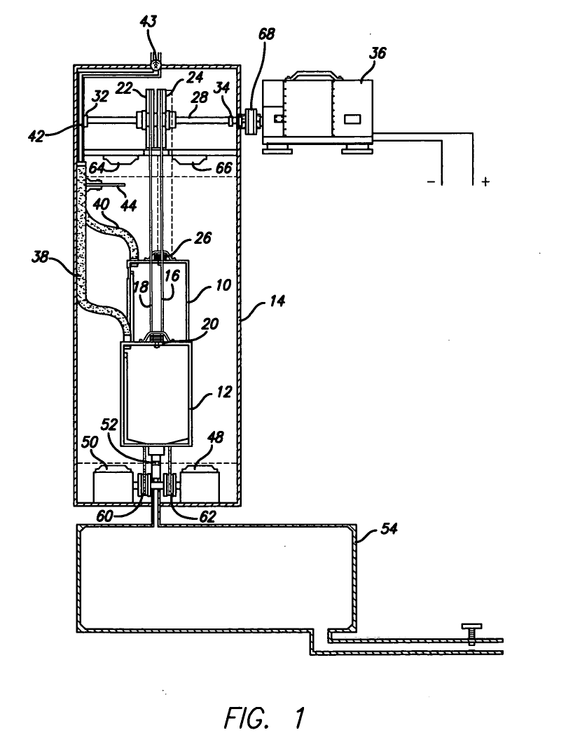

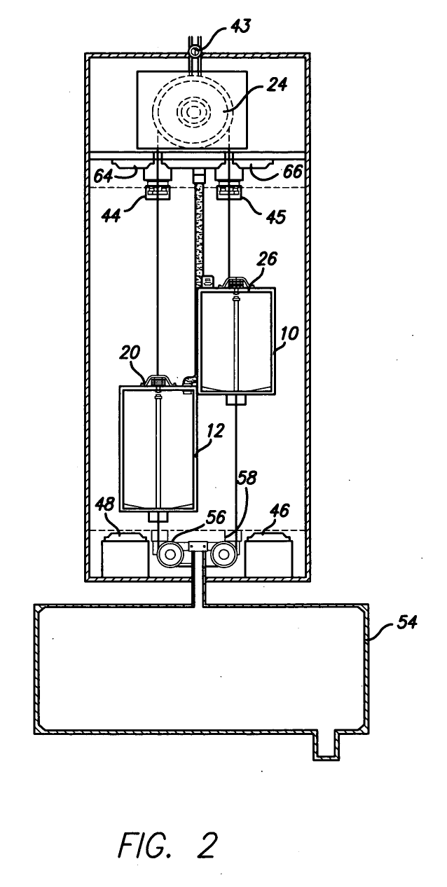

Referring now to FIGS. 1 and 2, there is shown, water tank 10 and water tank 12, both located in housing 14. A pair of chains 16, 18 are fixedly attached to the top 20 of tank 12. Chains 16 and 18 loop over the top of two upper flywheels 22, 24 and attach to the tops 20, 26 of tanks 10 and 12.

Flywheels 22, 24 are attached to an axle or shaft 28 which is attached between two bearings 32, 34 to a generator 36. Each of the tanks 10 and 12 have a flexible hose 38, 40 attached to the tops 20, 26 of tanks 10, 12. A water line 42 feeds water from the plumbing system of the structure, to flexible hoses 38, 40 which alternately transfer the water into the upper tank when it reaches its upper position. Pillars 64 and 66 act as stops when a tank reaches its upper position.

Sensors 44 and 45 sense when a tank reaches its upper level at which point a water valve 43 in water line 42 opens and the upper tank is filled with water. A gripping mechanism holds the upper tank until full and then a sensor releases the tank. Gravity then causes the filled tank to drop downward, which causes the empty tank to be raised up to the upper level where it is then filled with water and the process continues. When a full tank reaches the lower level, it rests against support pillars 46, 48, 50 and a fourth pillar, not shown. A lower sensor 56 or 58 then opens lower valve 52, so that all of the water in the lower tank empties into receiving tank 54 from which it is fed back into the home or building water system for normal use.

While the system has been described using electrical sensors to open and close the water valves for filling and emptying the tanks, mechanical means can also be used to fill and empty the tanks, such as a levers which are impacted by the movement of the tanks, which open and close the valves.

The system can easily be kept pollution free, so that the water which is emptied can go right back into the home or building system. This can be done by using pollution resistant materials and sealed tanks and valve fittings. If desired water purification substances can be added to the water.

The movement of the tanks 10, 12 turns shaft 28, which in turn turns generator 36 to produce electricity. The use of gear ratio, which is well known, can increase the rotational speed of the generator to produce more electricity.

Assuming that the weight of the water in one tank is 300 kg, the electric current produced by the generator would be about 40kvl per day. The amount of electricity consumed by an average household in one day is normally, approximately 30 to 35 kvl, thus enough electricity would be produced to operate an average household for one day.

Surplus electricity generated can be sold to the local electricity provider. In the event the gravity system is down for repairs, the system can be bypassed by a switch, which changes the water flow around the system.

If more output is needed, the number of water tanks can be increased or larger water tanks can be used, in conjunction with a larger generator. If needed, a tank may be placed at the top of the system and filled with water from the water source and the oscillating tanks can be filled from that tank. Also, if needed to increase speed of movement, a motor can be added to help move the tanks from their upper position to their lower position or from their lower position to their upper position.

Having thus described the invention, I claim:

1. A system for generating electricity for a structure receiving a water supply under pressure, comprising a plurality of oscillating tanks adapted to move from an upper position to a lower position by gravity, means to fill a tank with water from the structure water supply when the tank reaches its upper position, means to empty the water in the tank when the tank reaches its lower position by gravity, passing said water back into the structure water supply, a generator having a shaft, means to turn the shaft by the oscillating movement of the tanks.

2. The system of claim 1 in which at least one tank is raised to its upper position for each tank which reaches its lower position by gravity.

3. The system of claim 1 in which the tanks are suspended on a chain, which is suspended over a flywheel.

4. The system of claim 3 in which the flywheel is turned by the gravity movement of the tanks and the flywheel is operatively connected to the generator shaft.

5. The system of claim 4 further comprising means between the flywheel and generator to increase the rotational speed of the generator.

6. The system of claim 1 in which sensors control the filling and emptying of the tanks.

7. The system of claim 1 further comprising mechanical valves operably connected to the tanks, means to mechanically actuate the opening and closing of said valves as the tanks reach their upper and lower positions.

8. The system of claim 1 in which the tanks are filled through flexible hoses attached to each tank.

9. The system of claim 8 in which the flexible hoses reach from the tanks' upper position to their lower position.

10. The system of claim 1 in which the structure is a home or a building.

11. The system of claim 3 in which the chain is attached to the tops of each tank.

12. The system of claim 1 in which mechanical means actuated by the movement of the tanks controls the filling and emptying of the tanks.

13. The system of claim 1 in which the electricity created is utilized to operate electrical needs of the structure.

14. The system of claim 1 in which excess electricity produced is sold to an electricity supplier.
